(19) United States
(12) Patent Application Publication
(10) Pub. No.: US 2018/0240077 A1
(43) Pub. Date: Aug. 23, 2018

(54) SYSTEM AND METHOD FOR PREDICTING PRESENCE OF PEOPLE IN MEETINGS

(71) Applicant: Shravan Kumar Bansal, New Delhi (IN)

(72) Inventors: Saurabh Sharma, Delhi (IN); Shikhar Garg, New Delhi (IN); Chashmeet Singh, New Delhi (IN)

(21) Appl. No.: 15/863,933

(22) Filed: Jan. 7, 2018

(30) Foreign Application Priority Data
Feb. 17, 2017 (IN) 201711005763

(51) Int. Cl. G06Q 10/10; G06Q 10/06

(52) U.S. Cl. CPC G06Q 10/1095; G06Q 10/063114

(57) ABSTRACT

The present invention discloses a method to identify the availability of concerned person to attend a pre-scheduled meeting with a registered firm, to view the real time status of the meetings and events, sending and receiving notifications between the registered firms and to provide a platform for communication among the members of the registered firm in a public event/conference/exhibition/global convention.

### FIELD OF THE INVENTION

The present invention relates to a method for identifying the availability of concerned person for pre-schedule meeting in public events, to host the events, to attend the event invitation and to view the real time status of the meetings.

### BACKGROUND OF THE INVENTION

Global conventions and public events invite a large number of professionals from around the world to gather at one platform and have healthy professional conversations or discussions in relation to their prefixed meetings disclosing the time and venue of said meetings.

The organizer's and the attendee's of the meeting along with their respective teams enter into a strenuous situation in locating each other at the venue of the meetings or events. Mere names and contact details of both the party does not suffice in locating and recognizing each other at the venue. Also sometimes it happens that the one person waits for the other person at the meeting point with whom the meeting was fixed, and that person is busy in searching of other person on the basis of details that have shared between them at the time of scheduling meetings and in some cases the person does not even reached at the meeting point or they were not willing to attend the meeting, such conditions are very annoying for the person who is waiting for other person to meet.

There are certain available options through which one can identify the availability of a person to attend a meeting in a public event such as a dynamic meeting detection system that dynamically detects in-person meetings between mobile device users by using features detected from the surrounding environment with the help of mobile devices. Also, there are some systems that track the location of mobile phone by using a global positioning system (GPS) module, which allows the mobile phone device to be located by a third party device using a location query methodology. Some other possible options use the real-time information to dynamically augment appointment and schedule information. The present invention disclosed herein discusses about a tool to allow a close coordination among the parties for handling the pre-scheduled meetings, thereby minimizing effort in coordinating and scheduling meetings.

### OBJECTIVES OF THE INVENTION

The main objective of the present invention is to overcome the problem of identifying the availability of concerned person to attend the pre-scheduled meetings in the public events.

Another objective of the present invention is to provide a method to identify the availability of the concerned person from a registered firm in huge public gatherings such as global conventions, public events, conferences, exhibitions, national and international conventions etc.

Another objective of the present invention is to provide a method to identify the availability of concerned person from registered firm where registered firm is an individual, group of individuals, organizations, company and institutions.

Yet another objective of the present invention is to schedule events where at least one registered firm can host the event and other registered firm can receive the event invitations.

Yet another objective of the present invention is to provide real time notifications providing information regarding meetings and events.

Still yet another objective of the present invention is to provide the status of the meetings and events.

Still yet another objective of the present invention is to provide a platform to communicate between the members of the same registered firm.

Yet another objective of the invention is to provide a method that takes minimum start-up time and faster in performance.

### BRIEF DESCRIPTION OF DRAWINGS

The drawings described herein are for illustrative purposes only of selected embodiments and not all possible implementations, and are not intended to limit the scope of the present disclosure. Further objects and advantages of this invention will be more apparent from the ensuing description when read in conjunction with the accompanying drawing and wherein:

FIG. 1 is the block diagram depicting the method of identifying the availability of person in a conference.

FIG. 2 is the schematic illustration of the information architecture of the method.

Corresponding reference numerals indicate corresponding parts throughout the several views of the drawings.

### DETAIL DESCRIPTION OF INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

The present invention will be described in detail by reference to the flowcharts and drawings. The flowcharts and drawings are for illustrations and not intended to limit the scope of the invention.

Generally, the present invention relates to a solution for the problem faced by the people to identify the person with whom a meeting is pre-scheduled and his availability is not sure in a huge public gathering such as public events, conferences, exhibitions, national and international conventions etc., through the proposed system that provides a method to identify the availability of the concerned person/participants/attendees/professionals etc. from a registered firm in a conference to attend a pre-scheduled meeting, the method disclosed herewith executes by addition of a pre-fixed meeting, hosting & receiving invitation of events and viewing the notifications and real time status of the meetings. The word ‘event’ herein specifies any competition, contest, match, or a lecture etc. hosted by initiator or attendee other than a pre-decided meeting in a conference.

The principal users of the current invention are the registered firms where the firms may include an individual, group of individuals, organizations, company and institutions. Further, at least one registered firm is Meeting Initiators hereafter referred as ‘initiator’ and other registered firm is Meeting Attendees hereafter referred as ‘attendee’.

The initiators have to pre-schedule the meeting based on the availability of the attendee along with the conditions expressed by the attendees. The method disclosed in this invention has the ability to handle several meeting requests in parallel and resolve the clashes related to meeting timings (if any).

The method discussed hereafter runs on a programmable electronic device herein after referred as device, where programmable electronic device is a computer system, smart cellular phones, smart watches, tablets, laptops, personal digital assistant (PDA) and alike.

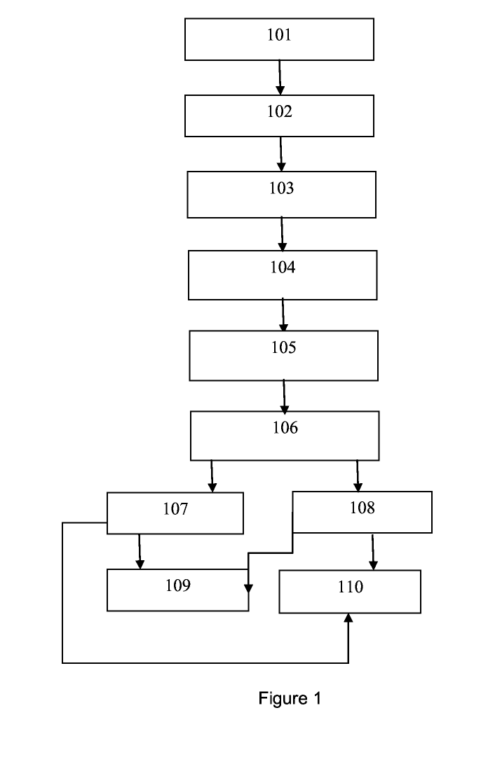

FIG. 1 represents a block diagram of the method to identify the availability of initiator and attendee in a conference for a pre-scheduled meeting; including a web interface 101; registration process 102; request for login credentials 103; login credentials 104; registration of firm member 105; generation of meetingid 106; addition of meeting 107; addition of events 108; the status of meeting 109; to send and receive notification regarding meeting 110.

The method of present invention to identify the availability of a registered firm in a conference to attend a pre-scheduled meeting comprising the steps of:
connecting of firm with a web interface 101;
registering of a firm 102 by entering the information/details of the firm which includes name of the firm, contact number, email id;
receiving of request for login credentials 103 to the administrator, where administrator controls the whole method;
generating of login credentials 104 by the administrator, using the information/details entered by the firm at the time of registration 102, login credentials are userid and password;
registering of at least one member 105 of the registered firm by using userid and password generated by the administrator.
generating the meetingid 106 to execute the pre-scheduled meeting in a conference by initiator;
adding of meeting 107 by using meetingid 106 along with information such as name of registered firm, name of at least one member of registered firm, contact number, email id for unique identification, photographs, venue, time and date;
viewing the real time status 109 of the meeting that represents the availability of the initiator and attendee for a pre-scheduled meeting;
sending and receiving the notifications 110 regarding meeting between initiator and attendee;

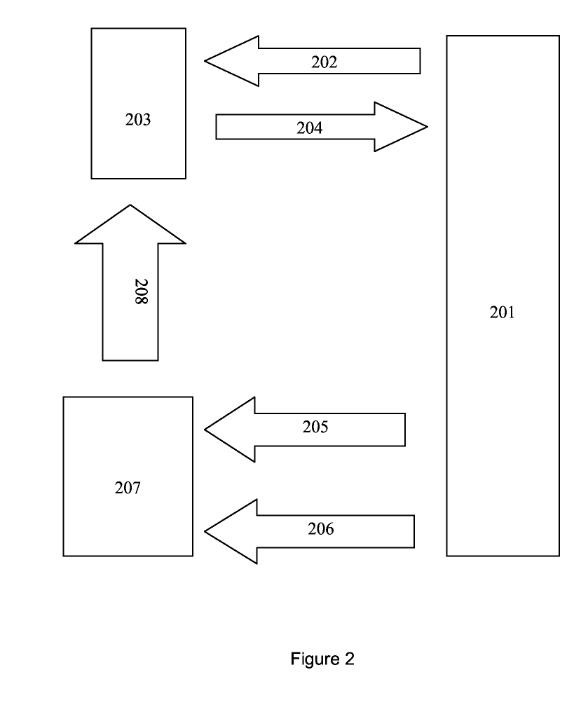

FIG. 2 depicts the illustrative view of the information architecture of the method disclosed in the present invention; including a device 201; registration request 202; Firebase Cloud Messaging (FCM) server 203; FCM token 204; login request with FCM token 205; message request 206; server 207; message request with FCM token 208.

Now according to FIG. 2, a device 201 uses a Firebase Cloud Messaging (FCM) platform to send a registration request 202 to FCM server 203, which further generates a FCM token 204 and sends FCM token to the device. The device now sends FCM token along with login data 205 to the server 207, where after the server 207 associates the FCM token 204 with the account and now the device 201 can send a message request 206 to the server 207, after which the server forwards these messages to the requisite account's devices by sending a request 208 to the FCM server.

In a preferred embodiment of the present invention to identify the availability of a registered firm in a conference to attend an event comprising the steps of:
connecting of firm with a web interface 101;
registering of a firm 102 by entering the information/details of the firm which includes name of the firm, contact number, email id;
receiving of request for login credentials 103 to the administrator, where administrator controls the whole method;
generating of login credentials 104 by the administrator, using the information/details entered by the firm at the time of registration 102, login credentials are userid and password;
registrating of at least one member 105 of the registered firm by using userid and password generated by the administrator.
generating the meetingid 106 to execute the pre-schedule meeting in a conference by initiator;
adding of event 108 by using meetingid 106 along with information of along with information such as name of registered firm, name of at least one member of registered firm, contact number, email id for unique identification, venue, time and date;
viewing the real time status 109 of the event that represents the information regarding an event hosted by initiator and event attended by an attendee;
sending and receiving the notifications 110 regarding a particular event between initiator and attendee;

According to an embodiment of the present invention, where method further provides a process of notification through which the initiator and attendee can send and receive personal messages from one another. These messages will be displayed to all members of the registered firm for a particular period of time after which they will remove on the basis of First in First out (FIFO).

In an embodiment of the invention provides a facility to view a list of events that are hosted by the initiator and attended by the attendee by using meetingid.

In another embodiment of the present invention, every member of the firm has a facility to view the real time status of the meeting by the help of colour codes, where different colors represent the real time status such as presence of initiator/attendee at location, presence of initiator/attendee at venue, absence of initiator/attendee and no response from initiator/attendee.

In one exemplary case, the real time status of the meeting is represented by green, orange, red and blue colors, where green color indicates the presence of at least one member of the registered firm at location (location herein refers to the place where the meeting is scheduled say a Hotel/Office etc), orange colour indicates the presence of at least one member of the registered firm at the venue (venue herein refers to the exact place or a meeting point where the initiator and attendee have decide to meet at a particular location, such as reception of Hotel, any conference hall in hotel or in Office etc.), red colour indicates the absence of the initiator/attendee and blue colour indicates that there is no response from the initiator/attendee.

Yet another embodiment of the present invention is to provide a platform for communicating amongst the members of the registered firm to share information with respect to meetings such as meeting completed, meeting pending, meeting under progress, attendee's presence at meeting point and meeting cancelled; Further, the present invention is to provides a platform for communicating amongst the members of the registered firm to share information with respect to events such as event completed, event pending, under progress, presence of at least one member of the registered firm at the event and event cancelled, viewing & sending notifications.

In one exemplary case, a registered firm of say three members has arrived to attend the pre-decided meetings with other registered firms in a conference. At least one member each amongst the members of the two registered firms (say Firm A and Firm B) have decided a venue to meet each other and due to some reasons the member of Firm A is unable to attend the meeting. In such a scenario the other member of Firm A can view the real time status of the meeting and pre-scheduled meeting may be attended by other member of the firm A.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

I claim:

1. A method for identifying the availability of concerned person in a conference comprising the steps of:
registration of a firm 102; wherein registration is performed through a web interface 101 by sending a registration request 202 to FCM server 203, said FCM server then generates a FCM token 204 and send said FCM token to a device 201;
generation of login credentials 104 by administrator, wherein said login credentials are user-id & password, these login credentials along with FCM token 204 is forwarded to server 207;
said server 207 associates said FCM token 204 with the account and whereafter said device 201 sends a message request 206 to the server 207, further said server 207 forwards said message to the requisite account by sending a request 208 to the FCM Server 203;
registration of at least one member 105 of the registered firm, wherein said at least one member 105 can get registered itself by using said user-id & password;
generation of meeting-id 106 between at least two registered firm, wherein said meeting-id 106 is generated to communicate between said at least two registered firms;
addition of pre-scheduled meeting 107; wherein pre-scheduled meeting between said at least two registered firm is identified by using said meeting-id 106;
addition of events 108; wherein said event 108 is identified by said meeting-id 106;
sending and receiving notifications 110 from and to said at least two registered member 105 of said registered firm 102 in the conference;
a facility for viewing the real time status 109 of the meeting;
a platform for communication amongst the members of the registered firm.

2. The method as claimed in claim 1, wherein the firm includes an individual, a group of individuals, organizations, company, and institution.

3. The method as claimed in claim 1, wherein the notifications 110 comprising the identification of availability of concerned person by marking themselves at venue, at location.

4. The method as claimed in claim 1, wherein the notification 110 further comprising the identification of availability of concerned person by displaying the messages, that have been send and receive between at least two registered firm.

5. The method as claimed in claim 1, wherein the real time status 109 is categorized as meeting completed, yet to complete, at least one member of the registered firm have not arrived at the location, at least one member of the registered firm have not reached at the venue, no response from the member of the registered firm and cancelation of meeting.

6. The method as claimed in claim 1, wherein the real time status 109 is further categorized as event hosted by at least one registered firm, invitation of the event to at least one registered firm, presence of the registered firm in the event.

7. The method as claimed in claim 1, wherein a platform for communication amongst the members of the registered firm is to share information with respect to meetings, events, viewing & sending notifications.
